(19) United States
(12) Patent Application Publication
(10) Pub. No.: US 2024/0373892 A1
(43) Pub. Date: Nov. 14, 2024

(54) FLAVOUR COMPOSITION

(71) Applicant: Givaudan SA, VERNIER (CH)

(72) Inventor: Giuseppe CORDA, Lelystad (NL)

(21) Appl. No.: 18/564,666

(22) PCT Filed: Jun. 7, 2022
(86) PCT No.: PCT/EP2022/065385

§ 371 Date: Nov. 28, 2023

Related U.S. Application Data
(60) Provisional application No. 63/209,181, filed on Jun. 10, 2021.

(51) Int. Cl. A23L 27/00; A23L 29/00; A23P 10/43

(52) U.S. Cl. CPC A23L 27/77; A23L 29/015; A23L 29/035; A23P 10/43

(57) ABSTRACT

Disclosed are shelf stable flavour compositions whose tendency to clump or cake is considerably reduced or even eliminated while also taking into account regulatory limits applicable to food products. The disclosure is further concerned with flavour compositions suitable for topical application to food products, such as snack foods. Methods for making the solid flavour composition and methods for seasoning a snack food are also disclosed.

### TECHNICAL FIELD

The present disclosure relates to flavour compositions and to products containing such compositions. The disclosure is further concerned with flavour compositions suitable for topical application to food products, such as snack foods.

### BACKGROUND

Many comestible compositions contain added flavours. The added flavours can be individual flavour-providing substances, but more commonly these substances are added as part of a flavour composition, which comprises other components in addition to the flavour. This is done in order to, among other things, provide better flavouring and preserve and protect the flavour-providing substance until its effect is required. The ideal flavour composition should exhibit a long-lasting shelf life and the correct flow index (flowability parameter) as dictated by the customer. However, flavour compositions, particularly snack seasonings based on complex powder blends generally exhibit poor shelf life and flowability, as they quickly cake or clump, making them difficult to use and necessitating their break-up prior to use, all of which is undesirable in the production of flavoured comestible compositions.

It has now been found that it is possible to prepare shelf stable flavour compositions whose tendency to clump or cake is considerably reduced or even eliminated while also taking into account regulatory limits applicable to food products.

### SUMMARY

Disclosed is a solid flavour composition comprising a plurality of individual components at least one of which is a flavour-providing substance and at least one of which is an auxiliary component, wherein the auxiliary component comprises a stearate compound and a carbonate compound.

Also disclosed is a food product comprising a topical coating of a solid flavour composition comprising a plurality of individual components at least one of which is a flavour-providing substance and at least one of which is an auxiliary component, wherein the auxiliary component comprises a stearate compound and a carbonate compound.

Further disclosed is a method of preparing a solid flavour composition comprising a plurality of individual components, at least one of which is a flavour-providing substance and at least one of which is an auxiliary component, wherein the auxiliary component comprises a stearate compound and a carbonate compound, wherein the method comprises forming particulate aggregates of the flavour-providing substance and the stearate compound, followed by blending of the aggregates with the carbonate compound.

Additionally disclosed is a method of seasoning a snack food comprising the step of applying topically to at least a portion of the surface of the snack food a solid flavour composition comprising a plurality of individual components at least one of which is a flavour-providing substance and at least one of which is an auxiliary component, wherein the auxiliary component comprises a stearate compound and a carbonate compound.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Shelf stable flavour compositions that exhibit a superior flow index (flowability parameter) that can be topically coated on to food products is achieved by the present disclosure. Furthermore, in exercise of the present disclosure, it is possible to produce seasoned snack foods on an industrial scale, in an operationally simple and clean manner.

The at least one flavour-providing substance in the flavour composition is selected in such a way as to impart or modify in a positive or pleasant way, the taste and/or aroma of a food product. The nature and type of the at least one flavour-providing substance present in the flavour composition does not warrant a particularly exhaustive description here, the skilled person being able to select them on the basis of its general knowledge and according to intended use or application and the desired organoleptic effect. In general terms, these substances belong to chemical classes as varied as alcohols, aldehydes, ketones, esters, ethers, acetates, nitriles, terpenoids, nitrogenous or sulphurous heterocyclic compounds and essential oils, and can be of natural or synthetic origin. Many of the flavour-providing substances useful in the flavour composition are described in reference texts such as the book by S. Arctander, Perfume and Flavour Chemicals, 1969, Montclair, N.J., USA, or its more recent versions, or in other works of a similar nature, as well as in the patent literature in the field of flavours and seasonings.

According to certain embodiments, the flavour composition may include one or more of the following types of ingredients: a tastant, such as salts, acids, such as citric, malic, tartaric, fumaric, lactic, acetic, malic, lactic and succinic acid sweeteners or mixtures thereof; tastant enhancers, such as MSG and ribonucleotides; dairy powders, e.g. whey powders, fat powders, creamers and the like; minerals, such as calcium phosphate, tri-potassium phosphate, or ammonium chloride; natural, nature identical or artificial flavours that are useful in culinary or savoury snack food applications, to provide a particular taste and/or aroma such as natural and/or synthetic flavour chemicals, flavour oils, essential oils and oleoresins; and ingredients that alter the body or mouthfeel of a seasoning, or which impart an organoleptic effect other than taste or aroma, such as tingling, salivating, lingering, succulence, heating, or an off-note masking effect, or mixtures thereof, such as any of the essential amino acids or mixtures thereof and food acids or mixtures thereof.

The at least one flavour-providing substance may comprise flavour oils, such as cinnamon oil, bay oil, anise oil, thyme oil, cedar leaf oil, oil of nutmeg, allspice, oil of sage, mace, oil of bitter almonds, and cassia oil; artificial, natural and synthetic flavours such as a cheese flavour, a fennel flavour, an all spice flavour, a cinnamon flavour, a mustard flavour, a cardamom flavour, a caraway flavour, a cumin flavour, a clove flavour, a pepper flavour, a coriander flavour, a savoury flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bay leaf flavour, and a wasabi flavour; a nut flavour such as an almond flavour, a hazelnut flavour, a macadamia nut flavour, a peanut flavour, a pecan flavour, a pistachio flavour, and a walnut flavour; and vegetable flavours, such as an onion flavour, a garlic flavour, a cabbage flavour, a carrot flavour, a celery flavour, mushroom flavour, and a tomato flavour.

Particular flavour-providing substances include salty, bitter, sweet and umami tastants, and also including savoury (e.g. kokumi) tastants. Non limiting examples include: NaCl, KCl, MSG, guanosine monophosphate (GMP), inosin monophosphate (IMP), ribonucleotides such as disodium inosinate, disodium guanylate, N-(2-hydroxyethyl)-lactamide, N-lactoyl-GMP, N-lactoyl tyramine, gamma amino butyric acid, allyl cysteine, 1-(2-hydroxy-4-methoxylphenyl)-3-(pyridine-2-yl)propan-1-one, arginine, potassium chloride, ammonium chloride, succinic acid, N-(2-methoxy-4-methyl benzyl)-N′-(2-(pyridin-2-yl)ethyl) oxalamide, N-(heptan-4-yl)benzo(D)(1,3)dioxole-5-carboxamide, N-(2,4-dimethoxybenzyl)-N′-(2-(pyridin-2-yl)ethyl) oxalamide, N-(2-methoxy-4-methyl benzyl)-N′-2(2-(5-methyl pyridin-2-yl)ethyl) oxalamide, and cyclopropyl-E,Z-2,6-nonadienamide.

In certain embodiments, the at least one flavour-providing substance is present in an amount of about 1 to about 95 wt. %, based on the total weight of the flavour composition. In certain embodiments, the at least one flavour-providing substance is present in an amount of about 1 to about 70 wt. %, based on the total weight of the flavour composition. In certain embodiments, the at least one flavour-providing substance is present in an amount of about 5 to about 60 wt. %, based on the total weight of the flavour composition. In certain embodiments, the at least one flavour-providing substance is present in an amount of about 10 to about 50 wt. %, based on the total weight of the flavour composition.

In certain embodiments, the stearate compound comprises at least one of calcium stearate, sodium stearate, potassium stearate, glyceryl stearate, propylene glycol monostearate, sorbitan stearate, triglyceryl monostearate, hexaglyceryl distearate, or decaglyceryl monostearate. In certain embodiments, the solid flavour composition comprises an alkali metal stearate and/or an alkaline earth metal stearate. In certain embodiments, the solid flavour composition comprises calcium stearate.

In certain embodiments, the stearate compound is present in an amount of about 0.01 wt. % to about 25 wt. %, based on the total weight of the flavour composition. In certain embodiments, the stearate compound is present in an amount of about 0.01 wt. % to about 10 wt. %, based on the total weight of the flavour composition. In certain embodiments, the stearate compound is present in an amount of about 0.1 wt. % to about 7 wt. %, based on the total weight of the flavour composition. In certain embodiments, the stearate compound is present in an amount of about 0.5 wt. % to about 5 wt. %, based on the total weight of the flavour composition.

In certain embodiments, the carbonate compound of the flavour composition comprises an alkali metal carbonate and/or an alkaline earth metal carbonate. In certain embodiments, the carbonate compound comprises calcium carbonate and/or magnesium carbonate.

In certain embodiments, the carbonate compound is present in an amount of about 0.01 wt. % to about 10 wt. %, based on the total weight of the flavour composition. In certain embodiments, the carbonate compound is present in an amount of about 0.01 wt. % to about 20 wt. %, based on the total weight of the flavour composition. In certain embodiments, the carbonate compound is present in an amount of about 0.1 wt. % to about 7 wt. %, based on the total weight of the flavour composition. In certain embodiments, the carbonate compound is present in an amount of about 0.5 wt. % to about 5 wt. %, based on the total weight of the flavour composition.

The flavour composition may contain one or more adjuvants. Adjuvants are ingredients that do not influence the flavour or other organoleptic properties of flavour composition, but which can affect its quality in other ways. Adjuvants may include colourants, which can add desirable colour or replace colour lost through processing; pH buffers; preservatives; anti-oxidants, and the like. Without limitation, adjuvants may also include solvents, emulsifiers, disintegrating agents and lubricants. Other examples of adjuvants for flavour compositions may be found in for example, “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Particular anti-oxidants vitamin C, vitamin E, rosemary extract, butylated hydroxyanisole (BHA), rosemary extract, and butylated hydroxytoluene (BHT).

Preservatives prevent or inhibit spoilage of food due to fungi, bacteria and other microorganisms. One or more preservatives may be used as part of the seasoning mixture. They may include, but are not limited to, preservatives such as sodium benzoate, sorbic acid and its salts thereof, and lauric arginate.

In certain embodiments, adjuvants may be employed in the flavour composition in an amount of about 0.01 to about 25 wt. %, based on the total weight of the flavour composition. In certain embodiments, adjuvants may be employed in the flavour composition in an amount of about 0.1 to about 15 wt. %, based on the total weight of the flavour composition. In certain embodiments, adjuvants may be employed in the flavour composition in an amount of about 0.5 to about 10 wt. %, based on the total weight of the flavour composition.

Particularly important seasoning compositions in the field of snack foods contain a mixture of ingredients able to impart a cheese flavour; e.g. nacho, cheddar, white cheddar, blue, mozzarella, asiago, american, brick, brie, feta, italian, monterey jack, muenster, provolone, ricotta, romano, swiss, taco or parmesan; a meaty flavour, e.g. beef, steak, chicken, smoked, mesquite, barbeque, seafood; an alliaceous flavour, e.g. onion, garlic, chive, leek; a tangy flavour, e.g. citric acid, vinegar and lemon; a spicy flavour, e.g. chilli, pepper, curry; or any combinations thereof.

According to certain embodiments, the solid flavour composition is substantially free of nanosilica (E551). Recent studies suggest that nanosilica (E551) is a potential safety concern in food products. In particular, the effects of E551 on human lung fibroblast cell viability, intracellular reactive oxygen species (ROS) levels, cell cycle phase, and the expression levels of metabolic stress-responsive genes were studied. The results suggest that E551 induces a dose-dependent cytotoxicity and changes in ROS levels and alters the gene expression and cell cycle. The present invention provides flavour compositions that exhibit superior flowability while also taking into account regulatory limits applicable to food products.

In the present disclosure, the term “substantially” refers to a degree of deviation that is sufficiently small so as to not measurably detract from the identified property or circumstance. The exact degree of deviation allowable may in some cases depend on the specific context. The phrase “substantially free” means that the composition excludes any amount more than trace impurities that are not intentionally added to the flavour composition, but which may be present in the starting materials from which the flavour composition is produced. In certain embodiments, the phrase “substantially free” means that the flavour composition excludes that component. In certain embodiments, the solid flavour composition comprises no nanosilica.

In certain embodiments, the disclosed flavour composition comprises at least one flavour-providing substance including all manner of known basic flavour components and other savoury (kokumi) tastants such as those described hereinabove; minerals, such as calcium phosphate, tri-potassium phosphate, or ammonium chloride; herb, spice and/or vegetable powders; fat powders; body blocks including yeast powders, HVP's and/or soy sauce products; processed modules including reaction flavours, such as those formed in Maillard reactions, and/or flavour precursor systems; aroma chemicals (natural and/or synthetic) which may include essential oils and oleoresins put together to impart the aroma of the desired alliaceous note; carriers and fillers, including lactose, maltodextrin, rice flour, and the like.

Also disclosed is method of preparing a solid flavour composition comprising a plurality of individual components, at least one of which is a flavour-providing substance and at least one of which is an auxiliary component, wherein the auxiliary component comprises a stearate compound and a carbonate compound, wherein the method comprises forming particulate aggregates of the flavour-providing substance and the stearate compound, followed by blending of the aggregates with the carbonate compound.

In certain embodiments, the disclosed flavour composition is a powder. Components of the flavour composition may be those available commercially in powder form, or they are ingredients which can be easily and economically rendered into powder form, for example by dissolving in water or an aqueous-miscible solvent, evaporating to form a cake and thereafter grinding or milling the cake into powder form. According to certain embodiments, the powder composition has excellent flowability and anti-caking or anti-clumping properties. The enhanced flowability allows the powder composition to be easily and uniformly applied to food products.

The classification of the flow of a powder can be quantified by the flow factor value. Powders in the de-aerated state can be classified on the basis of direct test results using a shear cell tester of a compression tackiness tester. The shear cell tester measures different shearing forces for corresponding normal force on consolidated powder samples. For each yield locus the unconfined yield stress and major consolidation stress σ₁ (i.e., the maximum normal stress underwent by a certain powder at a given state of compaction) can be obtained. Unconfined yield stress f, is the normal stress necessary to make the powder yield at zero shear stress (i.e., no shear forces in the planes perpendicular to the normal force). The flow factor ff is the ratio of the major consolidated σ₁ found from the yield locus to the unconfined yield strength f, as represented by the formula ff=σ₁/f₁.

In certain embodiments, the flavour composition has a flow index value of about 0.01 to about 0.5. In certain embodiments, the flavour composition has a flow index value of about 0.1 to about 0.4. In certain embodiments, the flavour composition has a flow index value of about 0.14 to about 0.24. In certain embodiments, the flavour composition has a flow index value of about 0.2 to about 0.3.

The flow index value may be ascertained from data obtained from any number of powder flow testers. Examples of powder flow testers include Brookfield PFT, Jenike shear cell, Shultze RST, and like. The flow index value may be ascertained by using a validated laboratory method of measuring flowability. The laboratory method may be designed by the testing laboratory, or it may be a standard method. Suitable standard methods include ASTM D6128 which describes the Flow Function test procedure, which consists of compressing and shearing powder samples in a defined annular shear cell, using an established well-defined methodology.

Particulate aggregates may be formed by granulation techniques known in the art. Granulation techniques include both dry and wet granulation. Wet granulation encompasses a variety of techniques that can be described under the term of fluid-bed drying or fluid-bed granulation. There are various methods of fluid-bed drying known in the art, including so-called “top spray”, “bottom spray”, and “tangential spray” drying.

Fluid-bed drying is the process of fluidizing a powder comprising particulate aggregates and then either spraying a coating solution or dispersion to build layers or coatings around the particulate aggregate to build a larger particle (of the “coated core” type); or spraying a binder solution or suspension onto a fluidized powder of particulate aggregates and causing those particulate aggregates to agglomerate and form particulate aggregates in the form of a composite of particulate aggregates. As soon as the desired particulate aggregates are formed, spraying of a coating material or a binder solution or suspension is terminated and the liquid evaporated.

A flavour composition according to the present invention, wherein the particulate aggregates are provided in the form of agglomerated particulate aggregates, the binding solution or suspension may be selected from an aqueous or an aqueous miscible solvent solution or suspension of a binding agent. Suitable binding agents can be selected from any food grade material that is capable of sticking together a loose mixture of fluidized particulate aggregates. One or more binding agents may be employed in a flavour composition according to the present invention. They may include, but are not limited to, dextrose, starch, cellulose, gum Arabic, dextrin and glycerin.

Seasoning compositions as hereinabove described may be applied topically to all manner of farinaceous or starch-based snack food known in the art. Particular snack foods include potato chips, crisps, nuts, tortilla-tostada, pretzels, cheese snacks, corn snacks, potato-snacks, ready-to-eat popcorn, microwaveable popcorn, pork rinds, nuts, crackers, and other baked or extruded food products.

Accordingly, in another aspect the invention provides a farinaceous or starch-based snack food comprising a topical coating of a flavour composition as herein defined. Methods of applying the flavour composition to a snack food are hereinafter described in order to allow the skilled person to understand further aspects of the present invention. Methods and apparatus for applying flavour compositions topically to snack foods are well known in the art. The primary objective of any method and/or apparatus is to apply flavour compositions in a uniform and consistent manner. The choice of particular apparatus one employs will depend upon such factors as the nature or state of the product to be coated, as well as the coating requirements for the product. The following are illustrative methods of applying the flavour composition to a food product.

A drum tumbler consists of a rotating drum or drums, configured in such a way that snack food pieces to be coated proceed along the length of the drum, entering uncoated and exiting coated with flavour composition. The rotating drum arrangement serves to cause the pieces to lift and fall through an oil mist that can be expressed from a nozzle or series of nozzles, coating the snack food and acting as an adhesive, before passing through a curtain of flavour composition powder delivered from a suitable metering device. Alternatively, a slurry of powder dispersed in an oleaginous carrier can be sprayed onto the pieces as they tumble and traverse through the drum. In yet another embodiment, the pieces could pass immediately from a fat fryer and into the drum. In this case, the oil fresh from the frying process can act as an adhesion aid for the flavour composition powder and as such, it might not be necessary to spray additional oil to assist with adhesion. Given the mechanical forces acting on the snack food pieces, the drum tumbler system is typically suitable for seasoning already cooked snack foods, which are sufficiently robust to withstand the tumbling process.

A conveyer-based applicator is another means by which one can apply the flavour composition to a snack food. Snack food in the form of a continuous sheet, or cut into finished pieces is placed on a surface, and is caused to pass sequentially or through an oil mist and a curtain of flavour composition powder. Or in the alternative, the powder can be dispersed in an oleaginous carrier to form a slurry, which is sprayed onto the snack food. The conveyer-based applicator is suitable for coating both cooked and uncooked snack food.

### EXAMPLES

The following examples are given solely for the purpose of illustration and are not to be construed as limitations of the present invention, as many variations of the invention are possible without departing from the spirit and scope of the present disclosure.

The following cheese flavour compositions were prepared using the same base ingredients with the following exceptions:
Flavour A—(flavour+0.8 wt. % silicon dioxide).
Flavour B—(flavour+0.8 wt. % silicon dioxide and 1% calcium stearate).
Flavour C—(flavour+1% calcium stearate and 4% calcium carbonate).
Flavour D—(flavour+1% calcium stearate and 4% magnesium carbonate).

Flavours A-D were stored at 40° C. and 50% relative humidity. The samples were checked by an expert panel after 0, 1, 4, 5, 6, 7 and 8 days. The results are shown in FIG. 1, below, in which:
1=powdery, no change from original
2=some small lumps visible
3=almost caked solid
4=completely caked solid

### FIG. 1

FIG. 1

| Time (days)) | 0 | 1 | 4 | 5 | 6 | 7 | 8 |
|---|---|---|---|---|---|---|---|
| Flavour A | 1 | 1 | 1 | 3 | 4 | 4 | 4 |
| Flavour B | 1 | 1 | 1 | 2 | 3 | 3 | 4 |
| Flavour C | 1 | 1 | 1 | 1 | 1 | 1 | 1 |
| Flavour D | 1 | 1 | 1 | 1 | 1 | 1 | 1 |

It is clear that over time the flavour compositions having both a stearate compound and a carbonate compound perform better than the flavour compositions having silicon dioxide, alone or in combination with a stearate compound. Applicant has surprisingly found that shelf stable flavour compositions whose tendency to clump or cake is considerably reduced or even eliminated can be obtained by the combination of a stearate compound and a carbonate compound. This was further demonstrated using Flavours A-D in a paprika flavour under the same test conditions. The results are shown in FIG. 2, below:

### FIG. 2

FIG. 2

| Time (h) | 0 | 1 | 4 | 5 | 6 | 7 | 8 |
|---|---|---|---|---|---|---|---|
| Flavour A | 1 | 1 | 1 | 4 | 4 | 4 | 4 |
| Flavour B | 1 | 1 | 2 | 2 | 3 | 4 | 4 |
| Flavour C | 1 | 1 | 1 | 1 | 1 | 1 | 2 |
| Flavour D | 1 | 1 | 1 | 1 | 1 | 1 | 1 |

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

While the flavour compositions, food products having a topical coating of the flavour composition, methods of preparing a solid flavour composition, and methods of seasoning a snack food have been described in connection with various embodiments, it is to be understood that other similar embodiments may be used or modifications and additions may be made to the described embodiments for performing the same function. Furthermore, the various illustrative embodiments may be combined to produce the desired results. Therefore, the flavour compositions, food products having a topical coating of the flavour composition, methods of preparing a solid flavour composition, and methods of seasoning a snack food should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A solid flavour composition comprising a plurality of individual components at least one of which is a flavour-providing substance and at least one of which is an auxiliary component, wherein the auxiliary component comprises a stearate compound and a carbonate compound.

2. The solid flavour composition of claim 1, wherein the stearate compound comprises at least one of calcium stearate, sodium stearate, potassium stearate, glyceryl stearate, propylene glycol monostearate, sorbitan stearate, triglyceryl monostearate, hexaglyceryl distearate, or decaglyceryl monostearate.

3. The solid flavour composition of claim 1, wherein the stearate compound comprises an alkali metal stearate and/or an alkaline earth metal stearate.

4. The solid flavour composition of claim 3, wherein the alkaline earth metal stearate comprises calcium stearate.

5. The solid flavour composition of claim 1, wherein the carbonate compound comprises an alkali metal carbonate and/or alkaline earth metal carbonate.

6. The solid flavour composition of claim 5, wherein the alkaline earth metal carbonate comprises calcium carbonate.

7. The solid flavour composition of claim 5, wherein the alkaline earth metal carbonate comprises magnesium carbonate.

8. The solid flavour composition of claim 1, wherein the stearate compound is present in an amount of 0.01 wt. % to 10 wt. %, based on the total weight of the solid flavour composition.

9. The solid flavour composition of claim 1, wherein the carbonate compound is present in an amount of 0.01 wt. % to 10 wt. %, based on the total weight of the solid flavour composition.

10. The solid flavour composition of claim 1, wherein the solid flavour composition comprises substantially no nanosilica.

11. The solid flavour composition of claim 1, wherein the flavour-providing substance imparts a cheese flavour, an alliaceous flavour, a tangy flavour and/or a spicy flavour.

12. The solid flavour composition of claim 1, wherein the solid flavour composition is a powder.

13. The solid flavour composition of claim 12, wherein the powder has a flow index value as measured by ASTM D6128 of 0.15 to 0.24.

14. The solid flavour composition of claim 13, wherein when stored at 40° C./50% humidity for a period of 8 days shows no caking or clumping.

15. A food product comprising a topical coating of the solid flavour composition according to claim 1.
